(19) United States
(12) Patent Application Publication
(10) Pub. No.: US 2013/0322726 A1
(43) Pub. Date: Dec. 5, 2013

(54) METHODS, APPARATUSES, ASSEMBLIES, CIRCUITS AND SYSTEMS FOR ASSESSING, ESTIMATING AND/OR DETERMINING RELATIVE POSITIONS, ALIGNMENTS, ORIENTATIONS AND ANGLES OF ROTATION OF A PORTION OF A BONE AND BETWEEN TWO OR MORE PORTIONS OF A BONE OR BONES

(71) Applicant: Ram Nathaniel, Tel Aviv (IL)

(72) Inventor: Ram Nathaniel, Tel Aviv (IL)

(73) Assignee: SURGIX LTD., Herzeliya Pituach (IL)

(21) Appl. No.: 13/985,576

(22) PCT Filed: Feb. 15, 2012
(86) PCT No.: PCT/IB12/50697

§ 371 Date: Aug. 15, 2013

Related U.S. Application Data
(60) Provisional application No. 61/442,845, filed on Feb. 15, 2011.
(60) Provisional application No. 61/487,360, filed on May 18, 2011.

(51) Int. Cl. G06T 7/00

(52) U.S. Cl. CPC G06T 7/0014
USPC 382/132

(57) ABSTRACT

The present invention includes methods, apparatuses, assemblies, circuits and systems for assessing, estimating and/or determining relative distances/positions, alignment, orientation and angles of rotation of a portion of a bone and between two or more portions of a bone, e.g. a fractured bone. According to some embodiments of the present invention, there may be provided a reference object (e.g. a reference grid), which reference object may include an array of reference markings visible in a radiographic image. The reference object may be used in conjunction with one or more radiographic imaging devices and image processing circuitry to facilitate determination of a 3D position and orientation of points within images acquired by the imaging devices from different angles and spatial relationships between these points.

### PRIORITY CLAIM

This application claims priority from:
U.S. Patent Application No. 61/442,845, titled “Methods, Circuits, Apparatus and Systems For Assessing, Estimating and/or Determining Relative Distances, Alignment, Orientation, and Angles of Rotation Between Two or More Portions of a Bone”, filed by the inventor of the present invention on Feb. 15, 2011, which is hereby incorporated into the present description in its entirety. and
U.S. Patent Application No. 61/487,360, titled “Method Apparatus, Assemblies, Circuits and System for Assessing Estimating and/or Determining Relative Distances Alignment Orientation and Angles of Rotation Between Two or More Portions of a Bone”, filed by the inventor of the present invention on May 18, 2011, which is hereby incorporated into the present description in its entirety.

### FIELD OF THE INVENTION

The invention is generally related to the field of radiation based imaging. More specifically, the invention relates to methods, apparatuses, assemblies, circuits and systems for assessing, estimating and/or determining relative distances/positions, alignment, orientation and angles of rotation of a portion of a bone and between two or more portions of a bone or bones.

### BACKGROUND

Fluoroscopic x-ray images play a key-role in a variety of surgical procedures, such as fracture reduction and fixation, pedicle screw insertion and implant positioning for treating hip fractures to name but a few.

The surgeon uses a mobile fluoroscopic x-ray machine (hereinafter: “C-arm”) in the operating room (hereinafter: “OR”), to determine the position and orientation of bones, implants and surgical instruments. X-ray fluoroscopy instruments have several limitations, one of which is a narrow field of view (hereinafter: “FOV”). The narrow FOV makes imaging a large region of interest (hereinafter: “ROI”) difficult to impossible, e.g., in the case of long bones and/or implant placement.

Information of particular interest and importance to surgeons during procedures involving surgical affixation of fractured bones, are the relative positions and relative orientations of end portions of the fractured bone. The narrow view provided by a C-arm, however, does not provide sufficient information for a surgeon to determine relative position, distance, alignment, orientation and/or rotational angles between two or more parts of a fractured bone, such as a femur bone.

Accordingly, there is a need in the field of medical imaging for improved methods, circuits, apparatus and systems for assessing, estimating and/or determining relative distances, alignment, orientation, and angles of rotation between two or more portions of a bone or bones.

### SUMMARY OF THE INVENTION

The present invention includes methods, apparatuses, assemblies, circuits and systems for assessing, estimating and/or determining relative distances/positions, alignment, orientation and angles of rotation of a portion of a bone and/or between two or more portions of a bone (e.g. a fractured bone). According to some embodiments of the present invention, there may be provided a reference object, such as a grid, which object may be placed within a field of view of a bone imager (e.g. X-ray or fluoroscope) acquiring images of a subject bone region, possibly from two or more different perspectives/angles. The reference object may include a set of patterned structures and/or shapes (also referred to as grid elements) detectable by a bone imager (e.g. visible in an x-ray image), whose shape, size, and/or positions (relative or absolute) within a reference frame (e.g. coordinate set/range) defined by the object may be identifiable by an image processing system.

According to further embodiments, one or more images of a first bone region, possibly taken from different perspectives, views or angles may be provided to and analyzed by the image processing system. The system may: (1) identify grid elements in the field of view of (present within) both images or a single image, (2) determine the distance and/or orientation of the grid elements relative to the imager and/or relative to another reference frame, and (3) estimate a position (e.g. 3D Coordinates) of one or more points on the bone in the first bone region. The position estimate may be a relative position within a reference frame defined by and/or otherwise related to a reference frame of the grid/object.

According to further embodiments of the present invention, one or more images of a second bone region, possibly taken from different perspectives, views or angles may be provided to and analyzed by the image processing system. The system may: (1) identify grid/object elements in the field of view of (present within) both images, (2) determine the distance and/or orientation of the grid elements relative to the imager and/or relative to another reference frame, and (3) estimate a position of one or more points (automatically identified or user indicated) on the bone in the second bone region. The position estimate may be a relative position within a reference frame defined by and/or otherwise related to a reference frame of the grid/object.

According to further embodiments, imaging of the first and second bone regions may be done using the same grid, which grid may remain stationary, or move in a measured manner, during the imaging of both regions. The first and second bone regions may also be kept substantially fixed during and between the imaging of both bone regions. Accordingly, after estimating the position (e.g. coordinates) and/or orientation, within the same reference frame, of one or more points in each of the two bone regions, the image processing system may estimate a distance between points in each of the two bone regions.

According to further embodiments of the present invention, the 3D position, in relation to the reference coordinate frame, of two or more points on each of two or more bone portions may be determined. Based on the relative position of two or more points on each of the two or more bone portions an alignment, in relation to the reference frame, of each bone portions may be determined. On the basis of the alignment of each of the bone portions in relation to the reference frame, an alignment between the two or more bone portions may be determined.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1: is a flowchart including exemplary steps of methods of operation of an exemplary imaging and image processing system for assessing, estimating and/or determining relative distances/positions, alignment, orientation and angles of rotation of a portion of a bone and between two or more portions of a bone or bones, all in accordance with some embodiments of the present invention.

FIG. 1A: is an alternative of a final portion of the flowchart in FIG. 1 including exemplary steps of methods of operation of an exemplary imaging and image processing system for assessing, estimating and/or determining relative distances/positions between two or more points on portions of a bone or bones, all in accordance with some embodiments of the present invention.

FIG. 1B: is an alternative of a final portion of the flowchart in FIG. 1 including exemplary steps of methods of operation of an exemplary imaging and image processing system for assessing, estimating and/or determining relative positions, alignment, orientation and angles of rotation between two or more portions of a bone or bones, all in accordance with some embodiments of the present invention.

FIG. 2: is an illustration of an exemplary reference object [100] (in this case a grid), including exemplary distinguishable reference markings, all in accordance with some embodiments of the present invention;

FIG. 3: is an illustration of an exemplary imaging system performing an exemplary imaging sequence, including acquisition of two images of a common bone portion (a knee) and a reference object from different angles, while the patient and the reference object remain stationary, all in accordance with some embodiments of the present invention. In the illustration, the patient leg [306] is illustrated atop the patient accommodation [301] with the reference object [100] positioned in between. The imaging system is illustrated in the two different imaging positions [304 & 305].

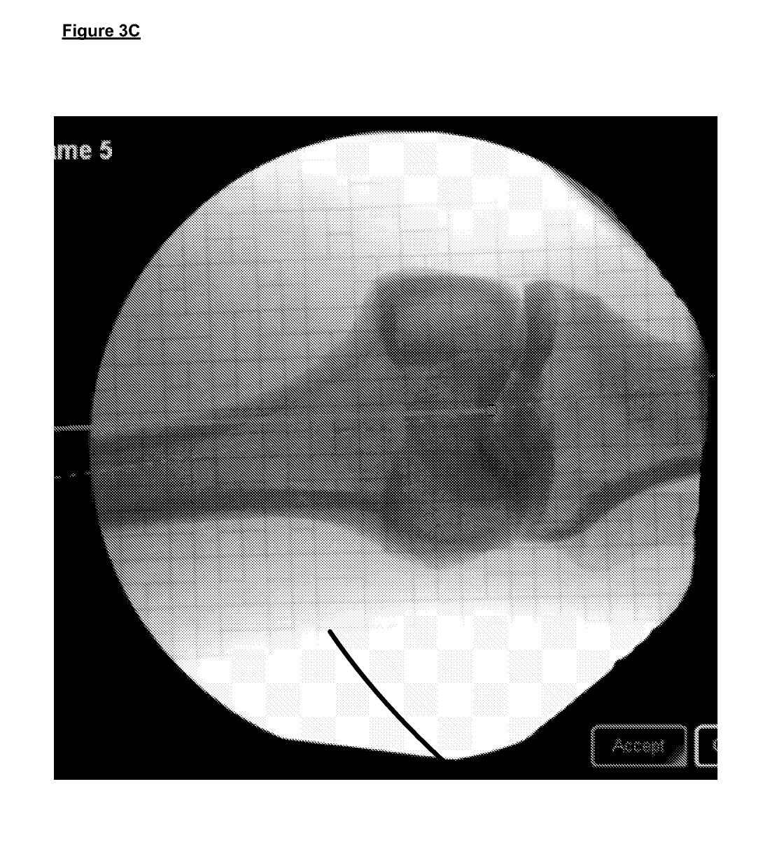

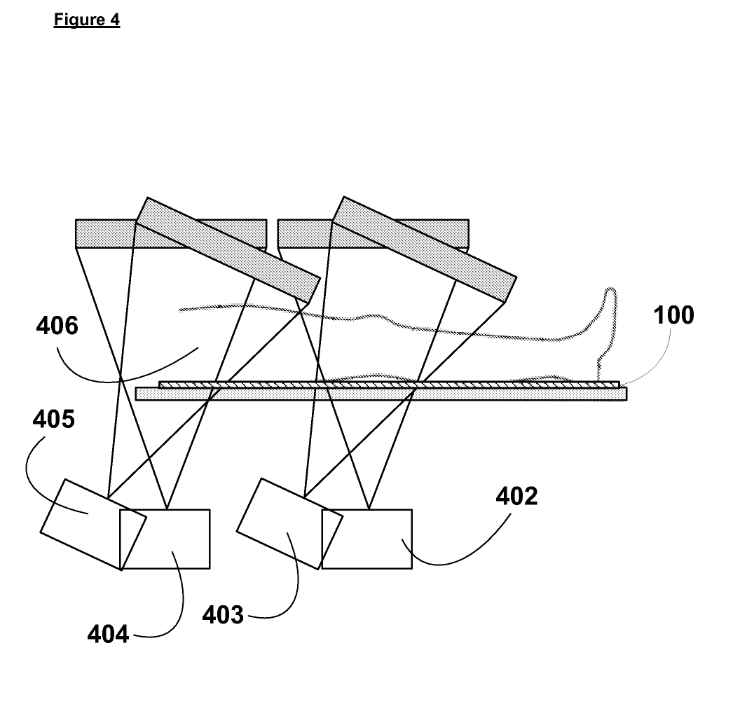

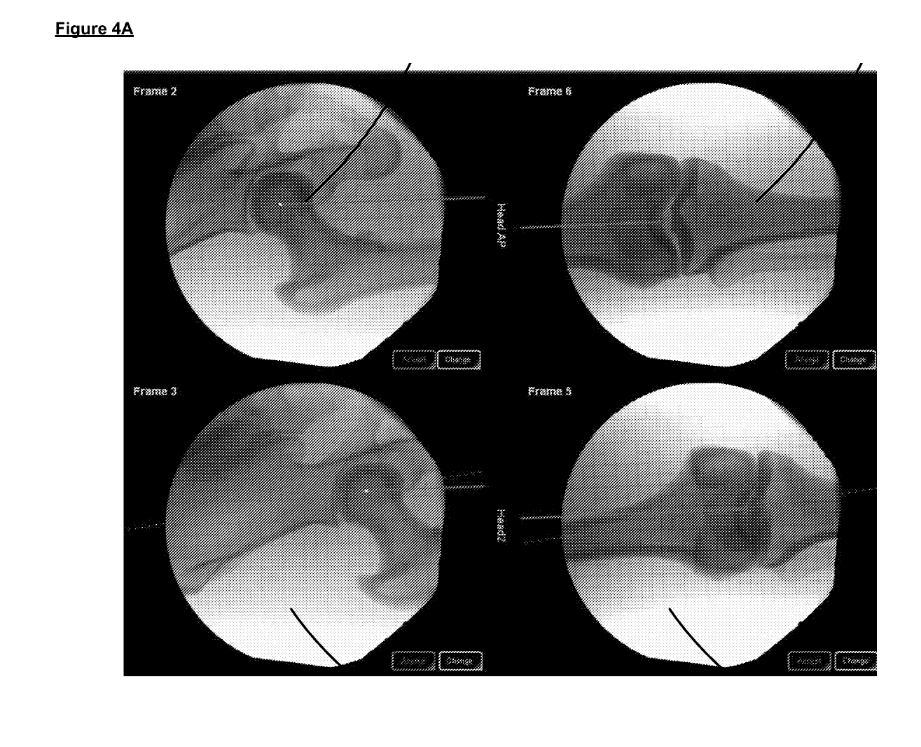

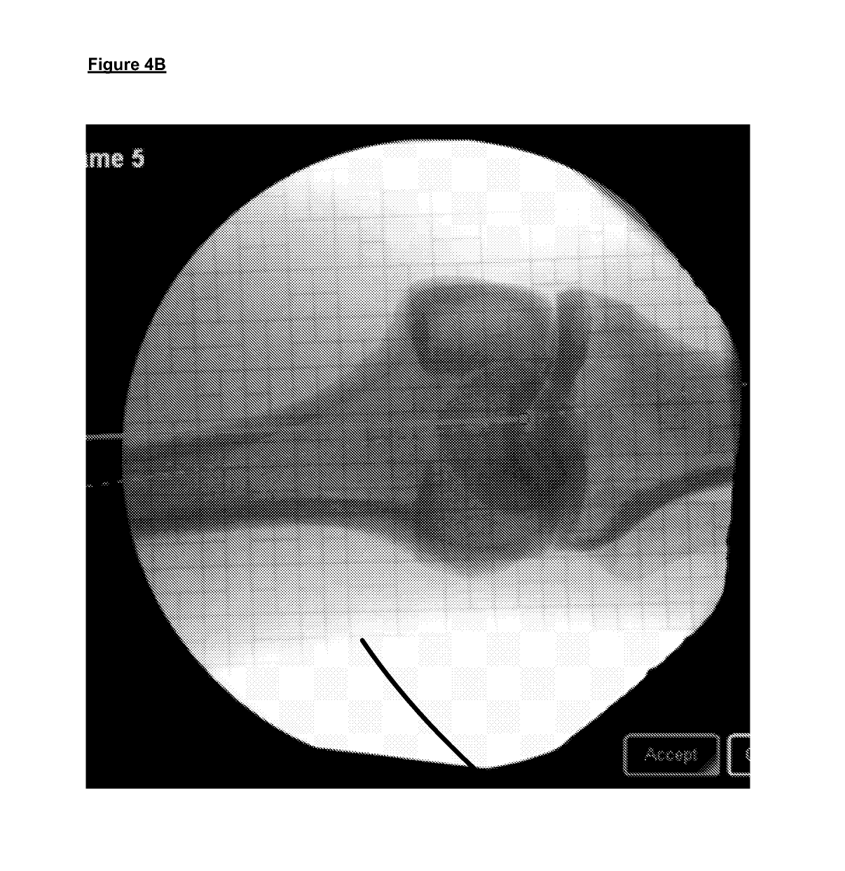

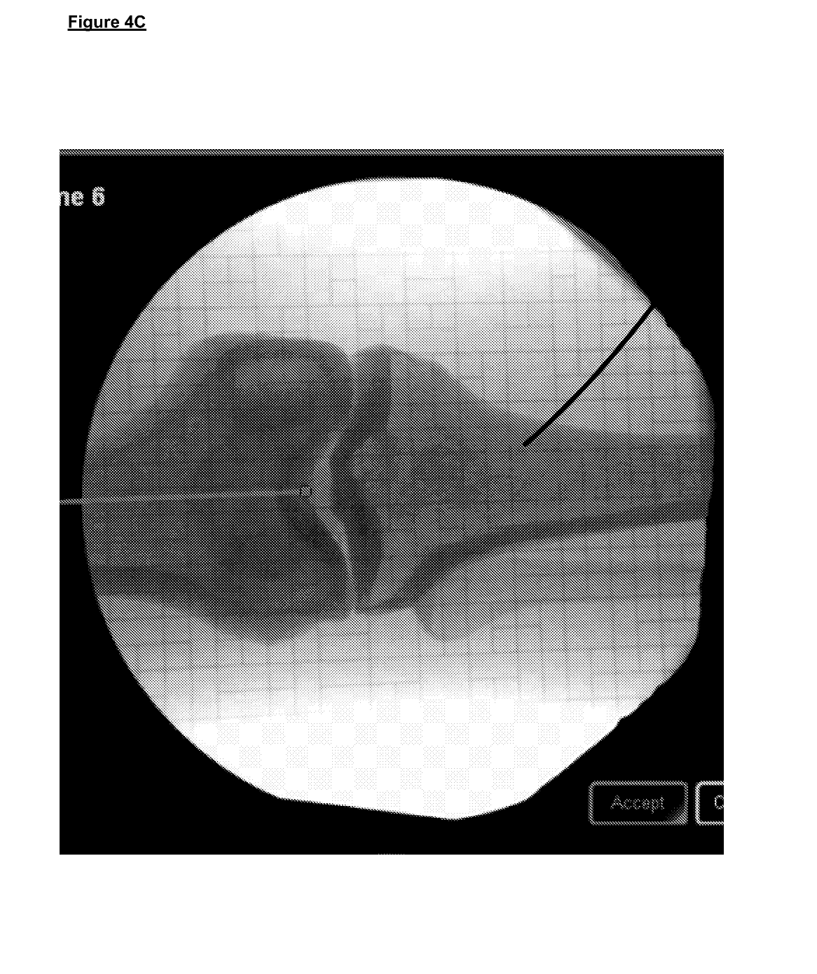

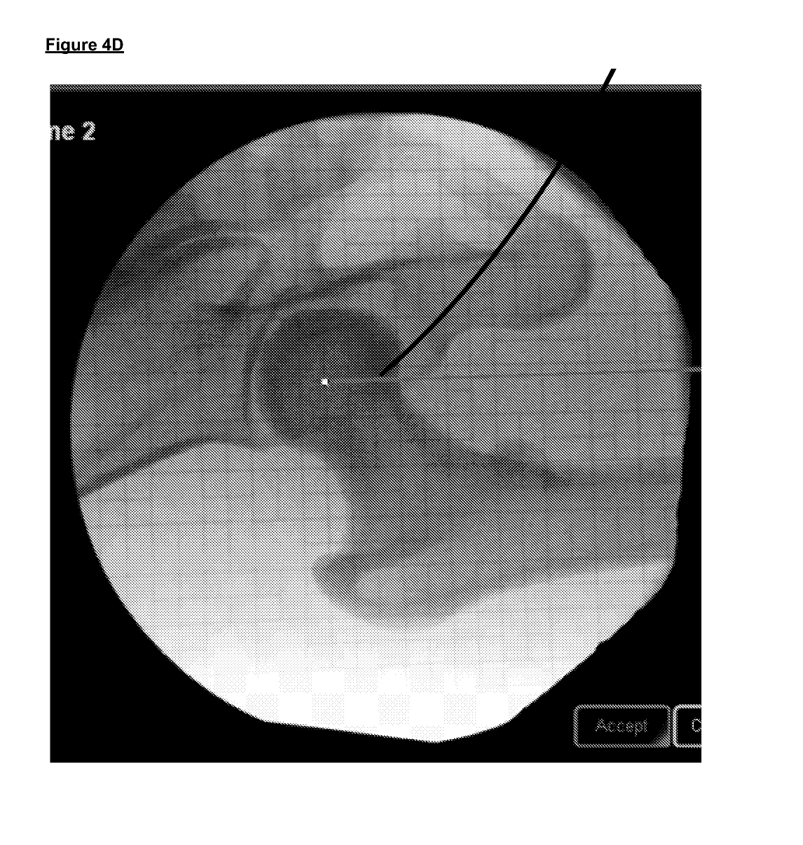

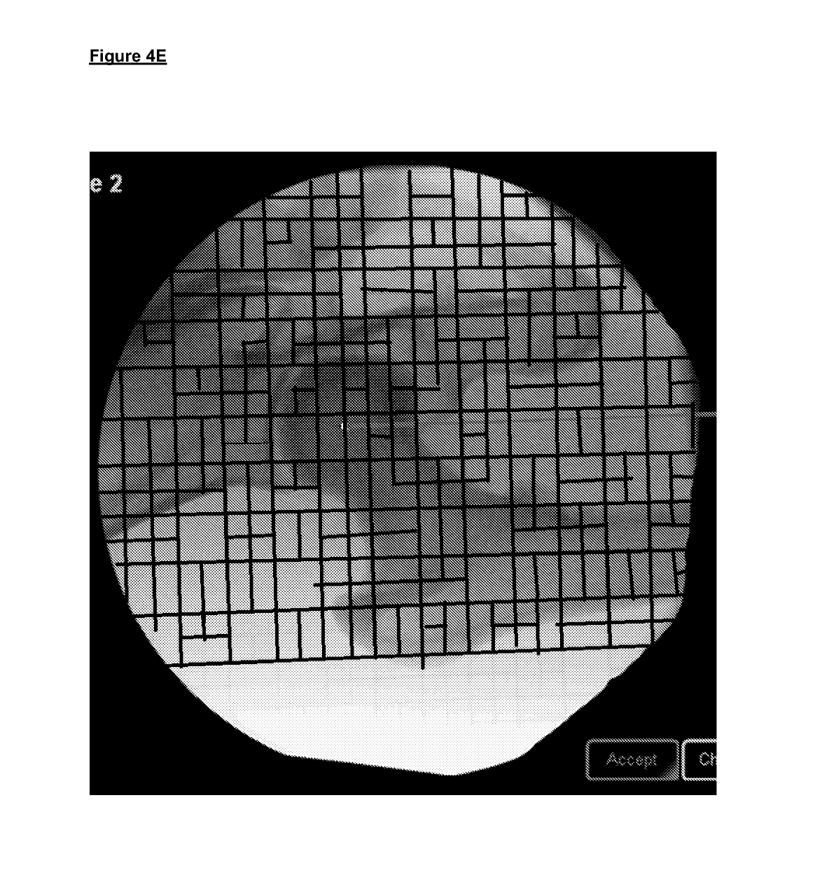

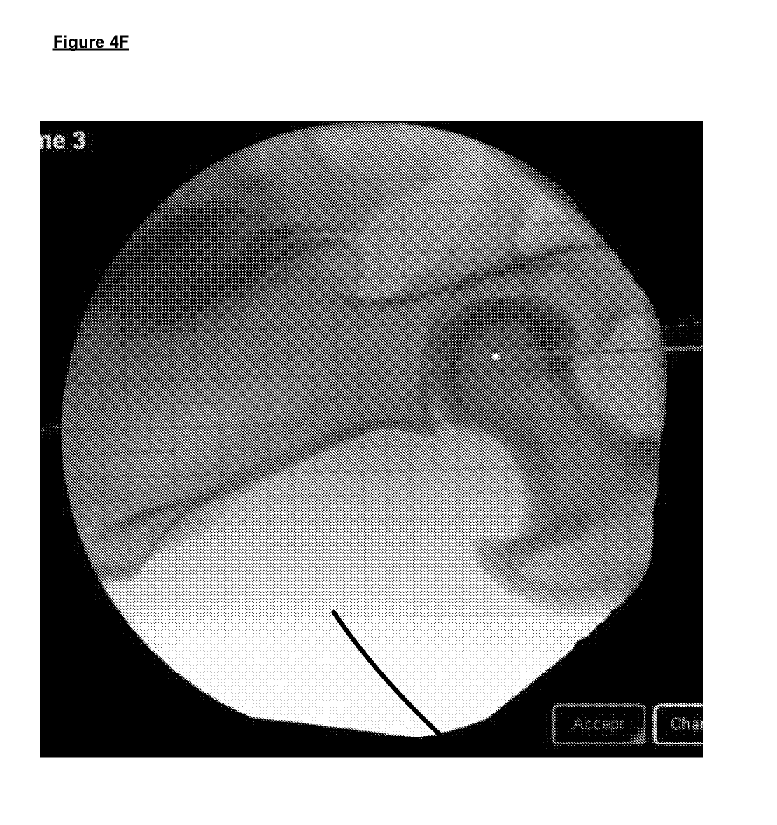

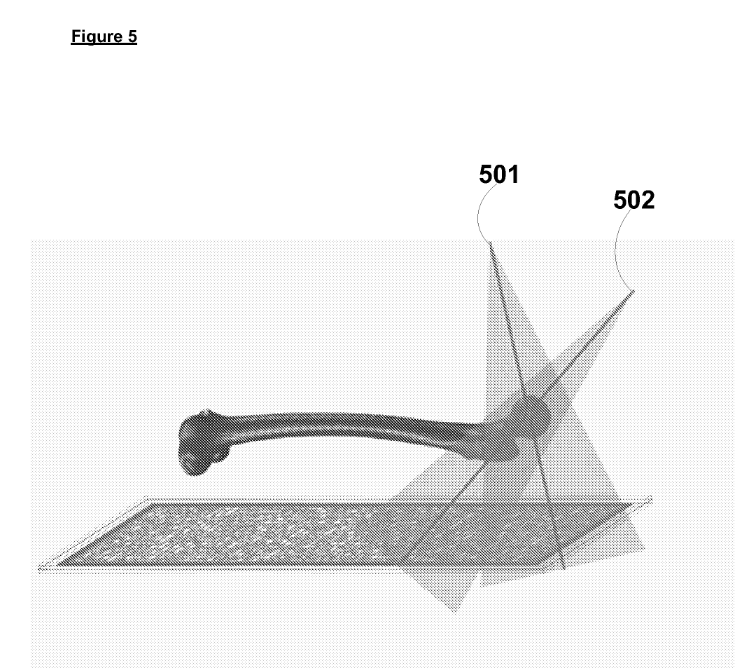

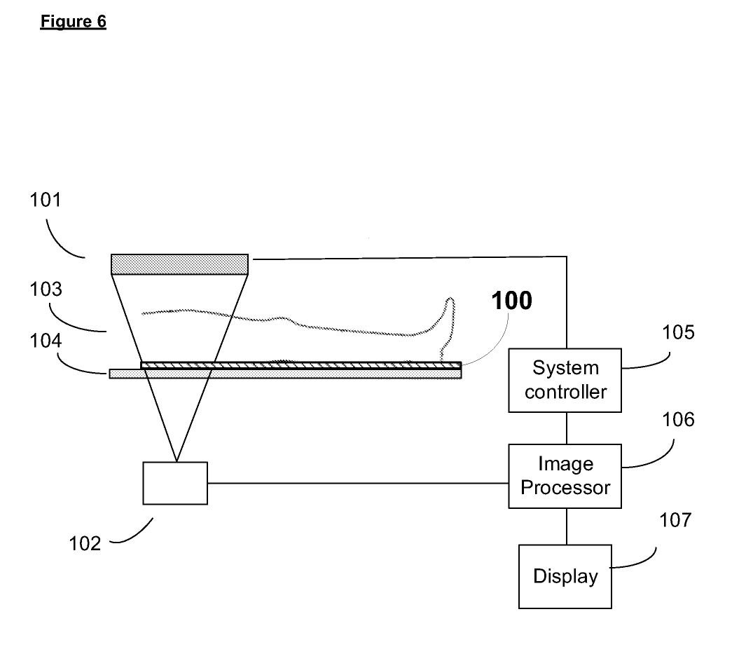

FIGS. 3A-3C: are exemplary x-ray images acquired by an exemplary imaging system performing an exemplary imaging sequence as detailed in FIG. 3, and including the marking of a point on the bone portion, all in accordance with some embodiments of the present invention. Wherein:
FIG. 3A includes two x-ray images acquired by an exemplary imaging system performing an exemplary imaging sequence as detailed in FIG. 3 and includes the marking of a point on the bone portion in each image (in red) and further includes a guideline (red dotted line) inserted by the image processing circuitry in order to assist in the marking of the point in the second image;
FIGS. 3B-3C are enlargements of the x-ray images presented in FIG. 3A;

FIG. 4: is an illustration of an exemplary imaging system performing two exemplary imaging sequences, wherein one sequence includes acquisition of two images of a first bone portion (a knee) from different angles and the second sequence includes acquisition of two images of a second bone portion (a hip) from different angles, and wherein the patient and the reference object remain stationary throughout the performance of both sequences, all in accordance with some embodiments of the present invention. In the illustration, the patient leg [406] is illustrated atop the patient accommodation with the reference object [100] positioned in between. The imaging system is illustrated in the four different imaging positions, two of the hip [404 & 405] and two of the knee [402 & 403];

FIGS. 4A-4F: are exemplary x-ray images acquired by an exemplary imaging system performing exemplary imaging sequences as detailed in FIG. 4, and including the marking of a point on the bone portion, all in accordance with some embodiments of the present invention, wherein:
FIG. 4A includes four x-ray images acquired by an exemplary imaging system performing an exemplary imaging sequence as detailed in FIG. 3 and includes the marking of a point on the bone portion in each image (in red) and further includes a guideline (red dotted line) inserted by the image processing circuitry in order to assist in the marking of the point in the second and fourth image;
FIGS. 4A-4F are enlargements of the x-ray images presented in FIG. 4A, wherein FIG. 4E is a modification of FIG. 4D including bolded grid lines added for illustrative purposes;

FIG. 5: is an illustration of an exemplary method for determining the 3D position of a point on a bone portion based on two images acquired of the bone portion and a reference object, from two different angles, all in accordance with some embodiments of the present invention. In the illustration the determined position and angle of the imaging device at the time of capture of two different images are marked [501 & 502]; and

FIG. 6: is a block diagram of an exemplary imaging and image processing system for assessing, estimating and/or determining relative distances/positions, alignment, orientation and angles of rotation of a portion of a bone and between two or more portions of a bone or bones, all in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

It should be understood that the accompanying drawings are presented solely to elucidate the following detailed description, are therefore, exemplary in nature and do not include all the possible permutations of the present invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, including mobile phone or any mobile device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer or phone or any other computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

It should be understood that any topology, technology and/or standard for computer networking (e.g. mesh networks, infiniband connections, RDMA, etc.), known today or to be devised in the future, may be applicable to the present invention.

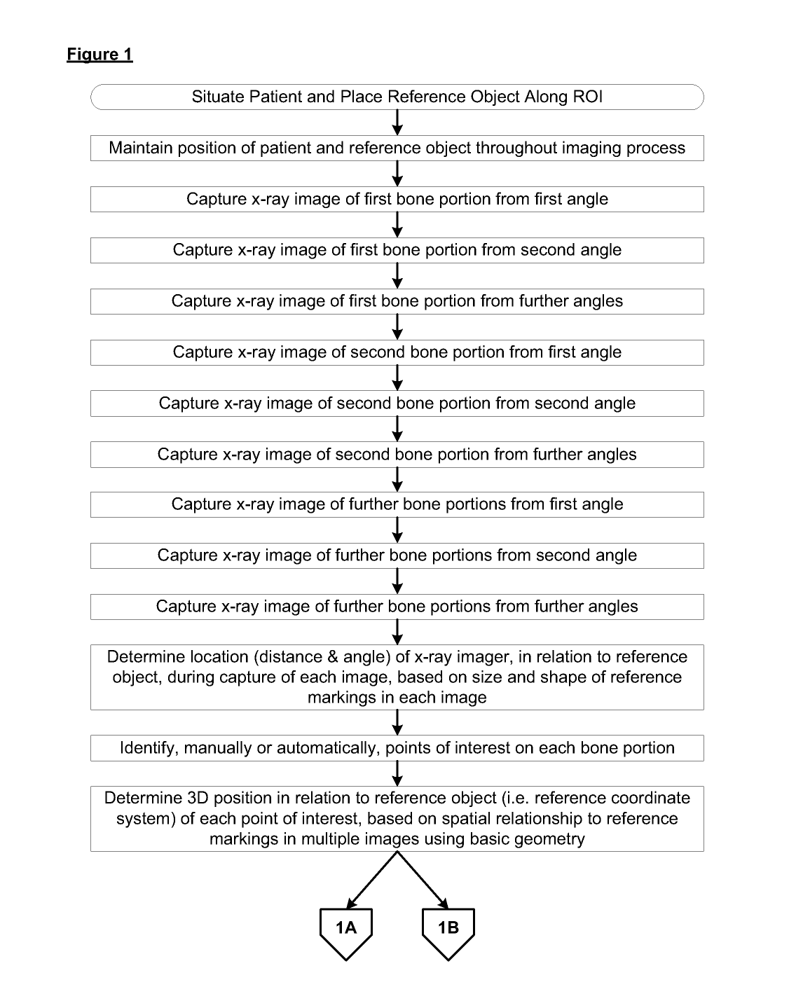

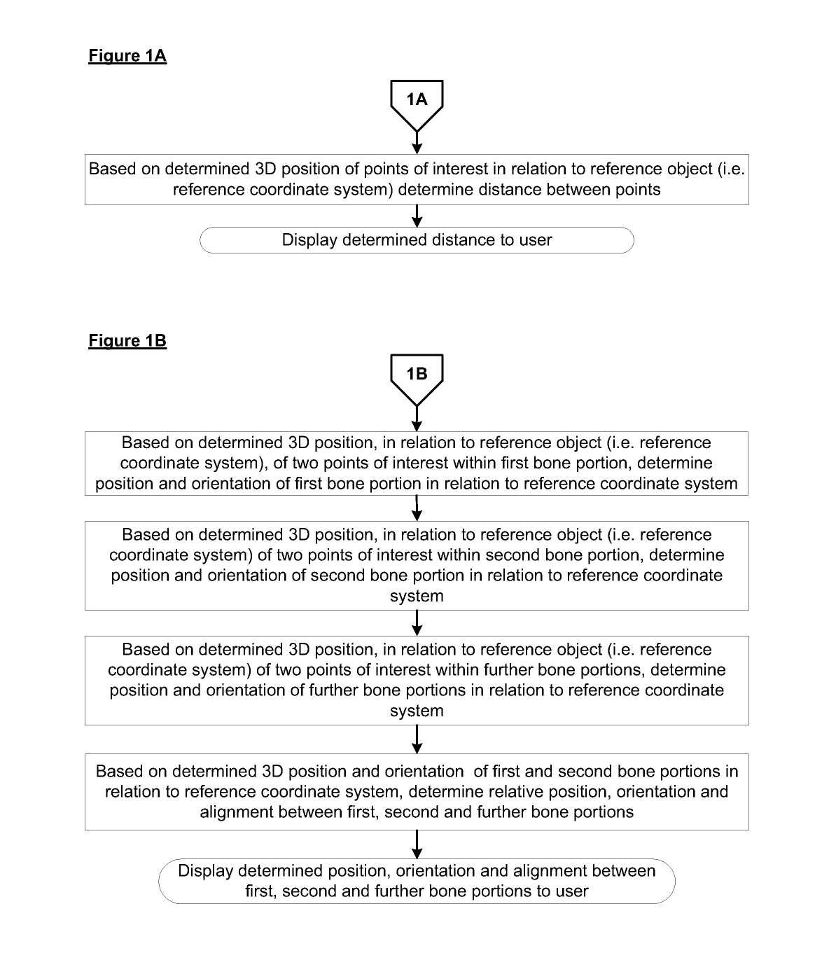

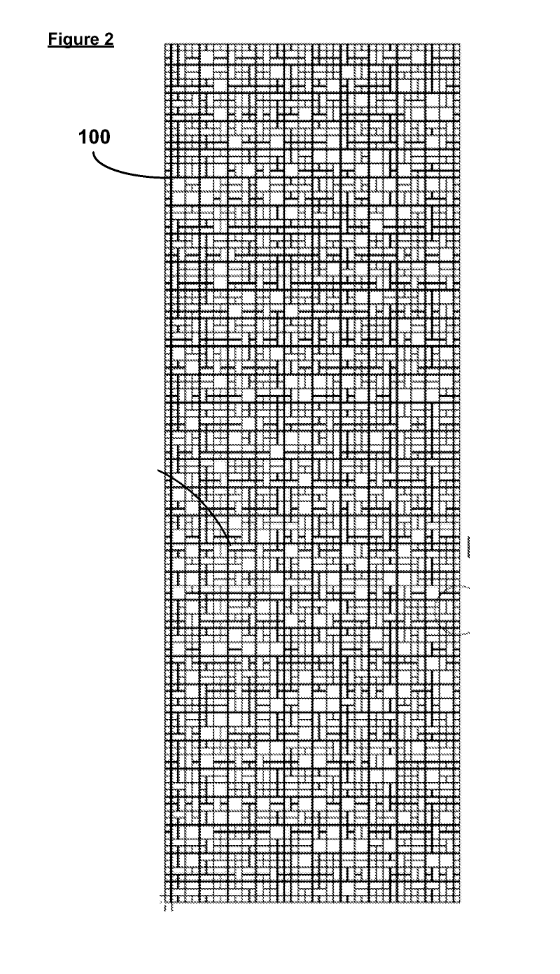

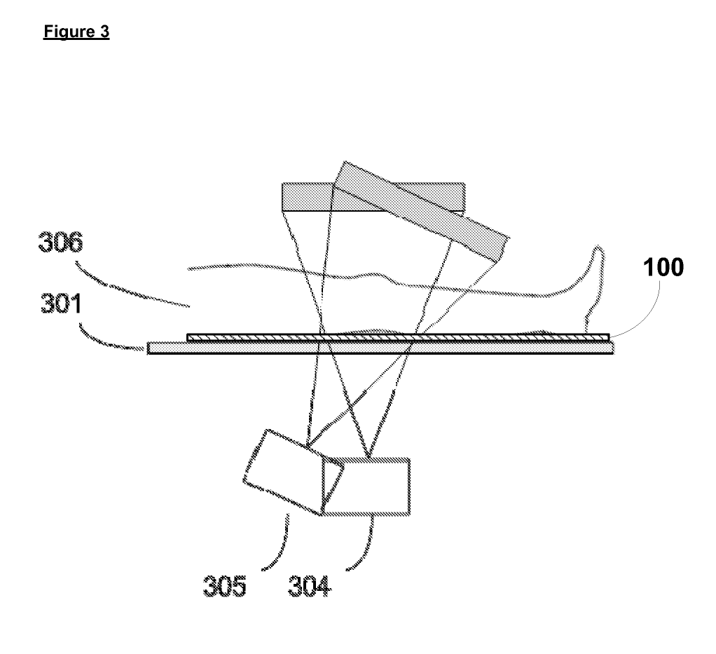

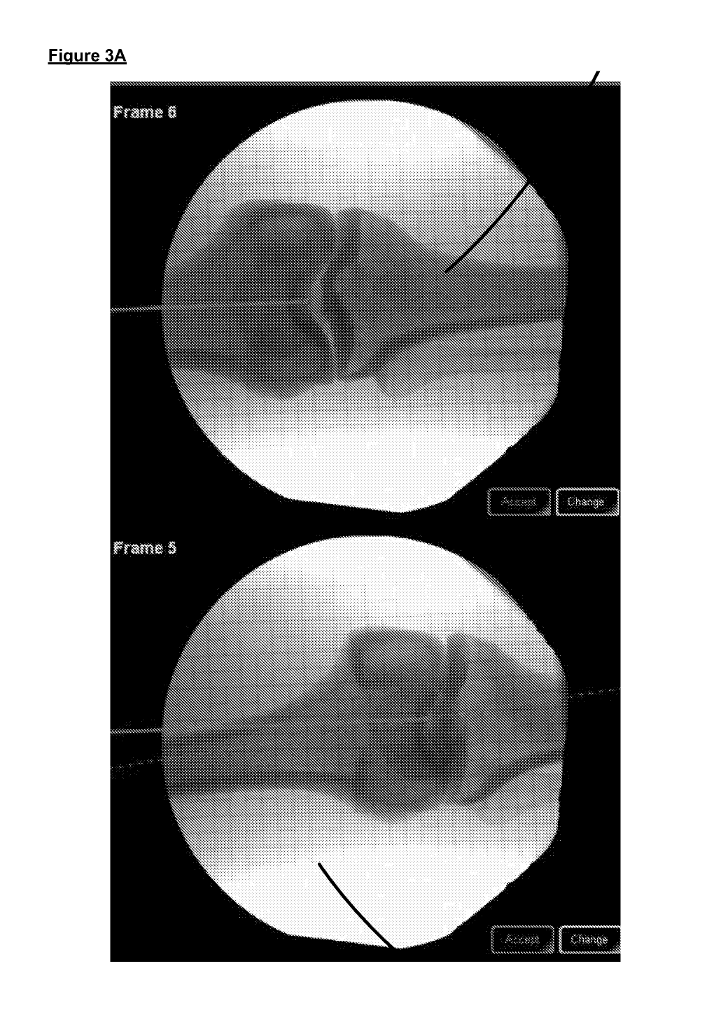

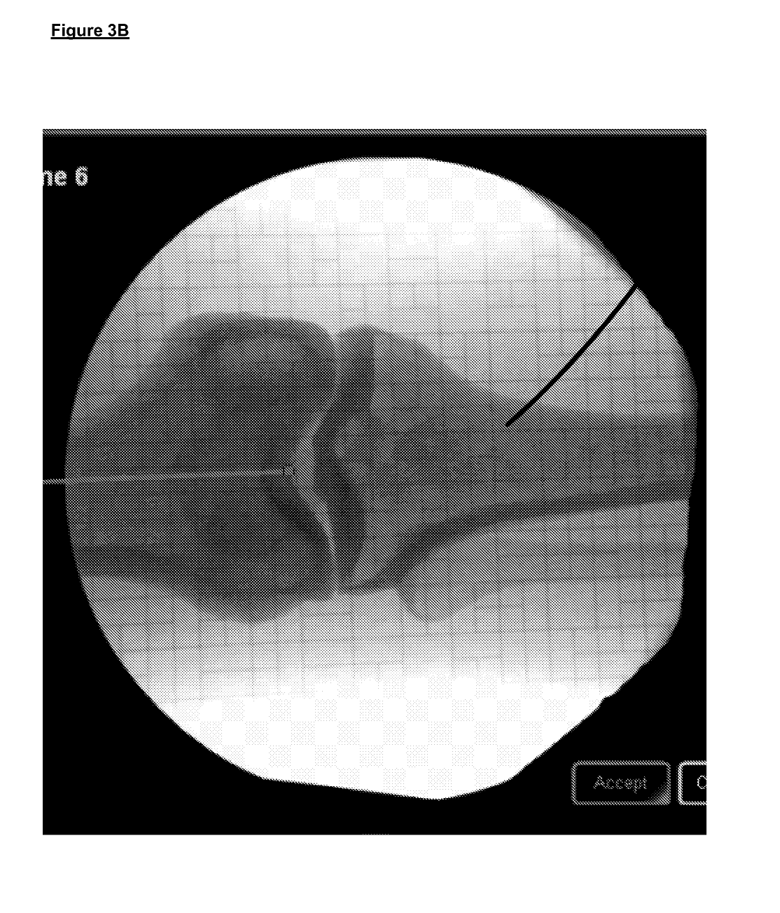

The present invention includes methods, apparatuses, assemblies, circuits and systems for assessing, estimating and/or determining relative distances/positions, alignment, orientation (i.e. distance, axial alignment, angle, rotational angle, etc.) and angles of rotation of a portion of a bone and between two or more portions of a bone or bones, e.g. a fractured bone or joint. According to some embodiments of the present invention, there may be provided a reference object (e.g. a reference grid [100]), which reference object may include an array of reference markings visible in a radiographic image [an example is shown in FIG. 2]. The reference object may be used in conjunction with one or more radiographic imaging devices [101/102] and image processing circuitry [106] to facilitate determination of a 3D position and orientation of points within images acquired by the imaging devices and spatial relationships between these points. The image processing circuitry may [see FIG. 1]: (1) analyze a set of two or more images, containing an anatomical element and a reference object, which images were acquired by the imaging devices from different angles while the anatomical element and the reference object remained stationary, (2) identify the reference markings within the field of view of the images and (3) use the identified reference markings to determine the 3D position and orientation of one or more points on the anatomical element. Furthermore, the image processing circuitry may be further adapted to analyze multiple sets of images, each set including two or more images containing an anatomical element and a portion of the reference object and captured from at least two different angles, wherein the reference object and anatomical elements remained stationary throughout the capturing of all the images in all the sets. The image processing circuitry may be adapted to extrapolate from the multiple sets spatial relationships between points on anatomical elements appearing in different images, by using the reference object as a common/reference plane.

According to some embodiments of the present invention, there may be provided a reference object [100] including reference markings or structures (hereby referred to collectively as “Reference Markings”) identifiable in a radiographic image. The reference object, excluding the reference markings, may be transparent to radiographic radiation, such that when appearing in a radiographic image only the reference markings may be visible in the image. For example, the reference object may comprise an array of metallic wire encased in a radiolucent casing. The reference object may also be fabricated from metal balls embedded in a plastic chassis, a combination of plastics having a different degree of radio opacity or any other appropriate combination of materials. A reference object may be any shape appropriate for its purpose. For example, a reference object may be a flat sheet or a long tube. According to further embodiments, there may be provided a number of reference objects suitable for imaging different areas of a subject's body or suitable for different procedures/situations, e.g. a flat sheet for leg imaging and a long tube for spinal imaging.

According to some embodiments of the present invention, reference markings on the reference object may be distinguishable from each other based on color, shape, size and/or any other distinguishing feature [as shown in FIG. 2]. Each reference marking and/or group of markings may have a pre-defined color, shape, size and/or other distinguishing feature. Accordingly, it may be possible to identify each individual reference marking and/or sets of markings according to its/their color, shape, size and/or other distinguishing feature. As such, when one or more reference markings appear in an image, it may be possible to identify the reference markings and according to their pre-defined shape size and/or orientation, determine the distance and angle between the imaging device which captured the image and the reference object and/or reference/common plane at the time the image was captured. In other words, as the shape and size of each reference marking is known, the angle and distance [501 & 502], at the time the image was captured, between the imaging device which captured the image and the reference object, may easily be determined based on the size and shape of the reference marking in the image, using basic geometry. Furthermore, if the location of each reference marking on the reference object is known, the relative position and orientation of the reference object may also be determined. Similarly, a 3D reference grid (“Reference Coordinate System”) defined by the position of the reference markings may be extrapolated within any image containing at least a portion of the reference markings Such a grid may be used as a reference/common plane between multiple images containing at least a portion of the reference markings, as long as the reference object remained stationary or its movement was tracked while the images were captured, even if the reference markings appearing in the images are not the same markings

Moreover, reference markings appearing within an image may further be used to determine the position and orientation of other objects/points in the image in relation to the reference object and/or reference/common plane [as demonstrated in FIG. 5], as described below.

According to further embodiments of the present invention, there may be provided a support chassis including a reference object mount adapted to support a reference object in a fixed location and orientation. A support chassis may be fabricated from any rigid material (e.g. aluminum). According to yet further embodiments, a support chassis may further include one or more mounts for one or more imaging system components (such as a radiation source). A support chassis may further include joints to allow manual and/or mechanical maneuvering of the mounts and further may include encoders adapted to signal to a processor the current position or movement of the chassis' moving parts, i.e. the current position and orientation of the reference object and/or imaging system component(s). A support chassis may be adjustable along one or more axis, and/or along one or more rotational angles. Furthermore, a support chassis may be functionally associated with a table, bed or other patient accommodation such that when a patient is seated/lying/standing on the patient accommodation the Chassis may position the reference object and/or imaging system component(s) in a fixed and/or adjustable position in relation to the patient.

According to some embodiments of the present invention, there may also be provided a radiographic imaging system comprising: (1) one or more radiographic imaging devices (e.g. a X-Ray machine) [101 & 102] which may be comprised of one or more radiation sources [101] and one or more radiation sensors or sensor arrays [102], (2) a C-arm or similar device adapted to support the imaging device component(s), (3) image processing circuitry [106] adapted to process images captured by the sensor(s) and (4) one or more displays [107].

It should be understood that the teachings of the present description may be implemented with any imaging technology, with the appropriate modifications, and should not be considered to be limited to radiographic imaging. Accordingly, radiographic imaging devices described herein may be replaced with other types of imaging devices and the reference markings modified accordingly to be visible to whatever imaging device is being used.

According to some embodiments of the present invention, the image processing circuitry may be adapted to process a set of images of an anatomical element [examples of which are shown in FIGS. 3A-3C], such as a bone or a portion of a bone (“Bone Region”) captured by the image sensor(s) while a reference object was positioned such that at least a portion of its reference markings were within the field of view and the subject and reference object remained stationary throughout all the images in the set. Each image within a set may be acquired from a different angle and/or distance in relation to the subject [as illustrated in FIG. 3]. The Image processing circuitry may be adapted to extrapolate 3D coordinates of one or more points of the bone region based on the relative size and shape of reference markings within the image in relation to these points, within two or more images of the bone region (as further described below). The image processing circuitry may contain a map of the reference markings and their size, shape and position, on a specific reference object, for this purpose. Furthermore, based on the 3D coordinates of two or points of the bone region, the image processing circuitry may be adapted to estimate/determine a 3D position and orientation of the bone region in relation to the reference object and/or a reference/common plane defined by the reference object [as demonstrated in FIG. 5].

According to further embodiments of the present invention, the image processing circuitry may be further adapted to process multiple sets of images of two or more bones or portions of bones (“Bone Regions”) captured by the image sensor(s), while a reference object was positioned such that at least a portion of its reference markings were within the field of view and the subject and reference object remained stationary, in relation to each other, throughout all the images in the sets. Each image within each set may be acquired from a different angle and/or distance in relation to the subject [as shown in FIG. 4]. The Image processing circuitry may be adapted to extrapolate 3D coordinates of one or more points of each of the bone regions based on the relative size and shape of reference markings within the image in relation to these points, within two or more images of the bone region (as further described below). Furthermore, based on the 3D coordinates of two or points of each of the bone regions, the image processing circuitry may be adapted to estimate/determine a 3D position and orientation of each of the bone regions in relation to the reference object and/or a common plane defined by the reference object. Accordingly, once a 3D position and orientation of each of the bone regions in relation to a common plane is determined/estimated, a 3D position and orientation between bone regions may be determined [see FIG. 1B]. In other words, based on a relative position and orientation of two or more bone regions in relation to the common plane, an alignment between the two or more regions may be determined.

According to some embodiments of the present invention, the image processing circuitry or an associated display module may be adapted to display to a user data (3D positions and orientations, in relation to the reference object, of points on bone regions and of bone regions themselves) extrapolated from the sets of images and may further be adapted to render the data on the display in a graphic form (e.g. a 3D model of the bone region(s)). According to further embodiments, the image processing circuitry or display module may be further adapted to display a combination of data and graphic rendering of the bone region(s) (e.g. a 3D model of the bone region(s) including an overlay of data relating to points on the bone region(s).

According to yet further embodiments, an interactive display module may be provided, allowing a user to request, via an appropriate interface (e.g. a touch screen, a pointing device, semi-automatic selection, etc.), from the image processing circuitry: (1) to present different display forms and angles, (2) to display or not display specific data, (3) to present data relating to specific points of interest on the bone regions selected by use of the interactive display, (4) to display data relating to relationships between different bone regions and/or points on bone regions and/or (5) any other operational command.

The image processing circuitry or display module may be further adapted to display concurrently two or more acquired images and/or models extrapolated from sets of images, and to provide within the presented images/models an informational overlay indicating position and/or orientation of points and/or regions within each of the images/models, possibly in relation to a common reference frame or common coordinate system (e.g. established by the reference object) or in relation to each other. The image processing circuitry may be adapted to determine and/or present information relating to a relative distance and/or a relative orientation between two or more captured bone regions or points on captured bone regions, even if they appear in separate images, as long as the bone region and reference object remained stationary (or the movement of the reference object was tracked) throughout the acquisition of all the images.

According to some embodiments of the present invention, the image processing circuitry may include one or more reference marker identification and/or image registration algorithms. For each of a set of acquired images, which images include a subject bone or bone region and reference markings of a reference object, which all remained stationary throughout the acquisition of the images, the one or more reference marker identification and/or image registration algorithms may: (1) estimate the orientation (e.g. angle) and position (e.g. distance and displacement) of the plane of the image within the common reference coordinate system (e.g. relative to a point, axis or plane of the common reference coordinate system), and/or (2) estimate a position and/or orientation of one or more points on the bone region (e.g. one or more portions on the imaged bone) within the common reference coordinate system. The one or more marker identification and/or image registration algorithms may extrapolate orientation of a given image's image plane relative to the common reference coordinate system by: (1) identifying which of the given reference markers appears in the image, (2) correlating/matching the two dimensional projection of the imaged marker (shape the imaged marker appears in the image) with one of a set of possible derived/predicted projections of the identified marker (shape the identified marker would have in a 2D image from various angles). Further, the algorithms may estimate/determine the distance of the image plane relative to a point on the common reference coordinate system by comparing the sizes of the imaged marker projections with the correlated/matched derived/predicted marker projections.

### Exemplary Process/System for Determining the Alignment between Two Portions of a Femur

The following is a description of some specific exemplary implementations of the present invention. These following specific exemplary embodiments of the present invention are presented to further clarify the present invention and the possible implementations of its principles, and as such, should not be understood to encompass the full scope of the present invention in any way. It should be clear to anyone of ordinary skill in the art that many other implementations of the present invention are possible.

According to some exemplary embodiments of the present invention, there may be provided devices, systems and methods for determining, possibly in real time, the alignment between two portions of a bone, such as a femur. These systems, devices and methods are hereto described, by way of example, in relation to a femur. It should be understood that the same principles may be applied to any human body part, with the appropriate modifications.

According to some exemplary embodiments of the present invention, there may be provided a reference object [100] comprised of a metal grid, embedded/encased in a radiolucent casing. The grid may include reference markings, which reference markings may be distinguishable from each other by shape. Accordingly, image processing circuitry may be able, based on the size and shape of reference markings appearing in a captured image, to determine the position and orientation of the C-arm which captured the image, in relation to the reference object, even if the image analyzed contains only a small portion of the reference object. According to such embodiments, the reference object may be placed under, over or to the side of a subject femur. 4 or more images of the femur and the reference object may be taken [as illustrated in FIG. 4], the first image may contain the femur head area and may be taken in an AP position [404], the second may contain the femur head area and may be taken in a tilted orientation [405], the third image may contain the knee area and may be taken in an AP position and orientation [402], and the fourth image may contain the knee area and may be taken in a tilted orientation [403].

A user may then be able to mark at least two 3D points in or near the femur [shown in FIGS. 4A-4F], using the position and orientation of the reference object as a common reference frame, wherein the anatomical landmarks, are either marked by the user, semi-automatically or automatically detected, in at least 2 images. According to some further embodiments of the present invention, the marking of an anatomical element may be performed by a user with assistance from processing circuitry [for an example of such assistance see dotted red line in FIGS. 4A, 4C & 4F]. For example, once a point on an anatomical element is marked by a user in one image, the image processing circuitry may present to the user the second image to be marked (e.g. an image captured from a second angle), wherein the line between the previous location of the imaging device (i.e. the determined location of the imaging device during the capture of the first image, in which the point was already marked) and the marked point is displayed [dotted red line in FIGS. 4A, 4C & 4F], showing the user possible locations of the desired point in the second image. In this manner mistaken markings of non-identical points may be avoided. According to further embodiments, a user may mark a point in one image and the same point's location may be determined automatically in a second image.

The calculation of a 3D position of a marked point from 2 images and the position and orientation of the reference object that appears in them may be done by simple geometric calculations and should be an easy task to those skilled in the art. [FIG. 5 illustrates determining the 3D position of a point at the end] of the femur using dedicated computer software that makes use of the reference object position and orientation.

According to some embodiments, the system [FIG. 1] may then use the 3D position of these points in order to assess, estimate and/or determine relative distances, alignment, orientation and angles of rotation between two or more portions of a bone. According to further embodiments, the image processing circuitry may be further adapted to automatically and/or upon command to assess, estimate and/or determine relative distances, alignment, orientation and angles of rotation between two or more portions of a bone. The image processing circuitry may be further adapted to display this information to the user, possibly in graphic or semi-graphic form (e.g. as an overlay of a model of the imaged femur). According to yet further embodiments, the image processing circuitry may automatically and/or upon command select the points to be analyzed.

In yet further embodiments of the invention, the system may be adapted to calculate the 3D position of a set of two or more points, and relate them to an additional set of points, which additional points do not have a determined 3D position. Rather, these additional points may be characterized by a 2D position within a 2D image. The system may be adapted to enable a user to and/or automatically assess, estimate and/or determine relative distances, alignment, orientation and angles of rotation between two or more portions of a bone, using these two points sets.

The measurement between points which 3D position is known and points which only a 2D position is known, may be done by treating the latter category using heuristics, such as to consider them to be on the same plane as the 3D points, or on the same plane as the markers, or any other heuristic positioning of these points in 3D space. It is clear that a person skilled in the art may use different heuristics for these calculations, all within the scope of the present invention.

The steps of exemplary methods for determining the distance between points on a bone and the alignment between two portions of a bone, according to some exemplary embodiments of the present invention may be [FIG. 1]:
1. Capture an x-ray image containing a first portion of a bone and a portion of a reference object within the field of view.
2. Capture a second x-ray image, from a different angle, containing the first portion and a portion of the reference object within the field of view, while the bone remains substantially in the same position in relation to the reference object.
3. Repeat stages 1-2 for a second portion of the bone, while the bone remains substantially in the same position in relation to the reference object.
4. Calculate the 3D position and orientation of the imaging system in relation to the reference object (reference frame) in each of the 4 x-ray images obtained in the previous steps.
*It should be understood that more than two angles of each bone portion may be captured in a similar manner. Equally, more than two bone portions may be imaged.

A—Determining the Distance between Two Points within the same Bone Portion [FIG. 1A]:
5A. Using the first 2 images, their corresponding imaging system positions and orientations, and the projection of the bone in each of the images, calculate the 3D position, in relation to the reference object (a reference/common plane), of two spatial points of interest on the first portion of the bone. The points of interest may be determined automatically or may be determined based on a user indication.
6A. Calculate the distance between the 3D points.

B—Determining the Distance between Two Points within Different Bone Portions:
5B. Using the first 2 images, their corresponding imaging system positions and orientations, and the projection of the bone in each of the images, calculate the 3D position, in relation to the reference object (a reference/common plane), of a spatial point of interest on the first portion of the bone.
6B. Repeat stage 5B for a point of interest on the second portion of the bone, using the second two images, their corresponding imaging system positions and orientations, and the projection of the bone in each of the images.
7B. Calculate the distance between the 3D points, which 3D positions, in relation to the reference object (a reference/common plane), were calculated in stages 5B and 6B.

C—Determining the Alignment (Relative Orientation) between Two Bone Portions [FIG. 1B]:
5C. Using the first 2 images, their corresponding imaging system positions and orientations, and the projection of the bone in each of the images, calculate the 3D position, in relation to the reference object (a reference/common plane), of two spatial points of interest on the first portion of the bone.
6C. Using the 3D position of the two points of interest calculate the orientation/alignment of the first portion of the bone in relation to the reference object (the reference/common plane).
7C. Repeat steps 5C and 5D for the second portion of the bone, using the second 2 images.
8C. Based on the alignment/orientation of each of the bone portions in relation to the reference object (reference/common plane), calculate the alignment (relative orientation) between the two bone portions.

According to some exemplary embodiments of the present invention, determining the 3D position of a point on a bone region appearing in an image, in relation to a reference frame, may include the following process, detailed here in pseudo code:

1. For each image in the provided image set I
a. Detect the reference markers in the image
b. Calculate the position and orientation of the imaging system with respect to the reference object

2. For each point of interest, P, of which location is marked in at least 2 images
a. For each image where the location of P is known
   i. Let S denote the 3D position of the x-ray source of the imaging system, relative to the position and orientation of the reference object when the image was taken.
   ii. Let p_{image} denote the marked position of the point p on the image.
   iii. Let T denote the 3D position of the point on the x-ray detector that corresponded to p_{image} when the image was taken.
   iv. Calculate the x-ray beam, B, from S to T.
b. Let the location of P be the 3D intersecting point of all the beams B.

According to some embodiments of the invention, more than 2 images of a bone portion may be captured from different positions and orientations.

According to some embodiments of the present invention, the process may be repeated for more than 2 points of interest, gathering a set of points of interest in or near the bone, which 3D positions are known in relation to the reference object.

According to some embodiments of the present invention, the image processing circuitry may linearly interpolate and extrapolate a 3D bone position and orientation, in relation to a reference object, using indicated points of interest.

According to some embodiments of the present invention, image processing circuitry may be adapted to measure distances and angles between points in or near a bone, using either points of interest or the interpolation or extrapolation of the bone 3D position and orientation, in relation to the reference object, as deduced from the calculations.

According to some further embodiments of the present invention, once a 3D bone position and orientation with respect to the reference object is calculated, the image processing circuitry may be further adapted to compose a panoramic image, using images that contain the reference object and one or more bones in the FOV, wherein the images may be stitched using the 3D position of the bone portions and not the marker positions (images may have to undergo a projection transformation and/or change the scale in order to fit on the bone calculated orientation). Note that in the present invention there is no requirement for the system to be able to reconstruct a 3D image of the bone.

It should be clear that systems and methods, in accordance with different embodiments of the present invention may include many different possible combinations of the above described components, accordingly providing different combinations of features.

It should also be understood by one of skill in the art that some of the functions described as being performed by a specific component of the system may be performed by a different component of the system in other embodiments of this invention.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

I claim:

1. A system for determining three dimensional positions of points in radiographic images, comprising:
a radiographic imager for acquiring two-dimensional images of a first anatomical element of a subject from at least two different angles;
a reference object including reference markings visible in a radiographic image, which reference markings are distinguishable from each other based on a visual characteristic and have known or ascertainable geometric characteristics and spatial relationships between them, said object being configured to be placed in the vicinity of the first anatomical element such that at least one reference marking of said object will appear in a field of view of each of the two-dimensional images taken from two or more angles; and
image processing circuitry for extrapolating a three dimensional position, in relation to said reference object, of a first point on the anatomical element, which first point is visible in at least two images acquired by said imager from different angles, wherein said extrapolating factors a geometric characteristic of projections of the reference marking appearing in a field of view of the at least two images.

2. The system according to claim 1, wherein said image processing circuitry further extrapolates a three dimensional position, in relation to said reference object, of a second point on the first anatomical element, which second point is visible in the at least two images acquired by said imager from different angles, wherein said extrapolating of the position of the second point factors a geometric characteristic of projections of the reference marking appearing in a field of view of the at least two images; and
wherein said image processing circuitry further extrapolates a three dimensional position and orientation, in relation to the reference object, of the first anatomical element, based on the extrapolated positions of the first and second points.

3. The system according to claim 1, wherein said image processing circuitry further extrapolates a three dimensional position, in relation to said reference object, of a second point on a second anatomical element, which second point is visible in at least two other images acquired by said imager from different angles, wherein said extrapolating of the position of the second point factors a geometric characteristic of projections of the reference marking appearing in a field of view of the at least two other images; and
wherein said image processing circuitry further extrapolates a distance between the first and second points, based on the extrapolated positions of the first and second points.

4. The system according to claim 3, wherein said image processing circuitry further determines an alignment of the first and second anatomical elements in relation to said reference object, based on the extrapolated positions of the first and second points.

5. The system according to claim 1, further comprising a display and a rendering module for displaying upon said display a graphic rendering of the extrapolated position.

6. The system according to claim 1, further comprising an interactive display adapted to receive a user selection of the first point.

7. A system for determining spatial relations between two or more anatomical elements, comprising:
a radiographic imager for acquiring two-dimensional images of two or more anatomical elements of a subject, each from at least two different angles;
a reference object including reference markings, which reference markings are distinguishable from each other based on a visual characteristic and have known or ascertainable geometric characteristics and spatial relationships between them, said object being configured to be placed in the vicinity of the two or more anatomical elements such that for each of the two or more elements at least one reference marking of said object will appear in a field of view of at least two of the two-dimensional images of the element, taken from different angles; and
image processing circuitry for extrapolating a three dimensional spatial relationship between the two or more anatomical elements, based on at least two images of each of the elements, acquired by said imager from different angles, wherein said extrapolating factors geometric characteristics of projections of the reference markings appearing in a field of view of the at least two images of each element.

8. The system according to claim 7, further comprising a display and a rendering module for displaying upon said display a graphic rendering of the extrapolated relationship.

9. The system according to claim 8, wherein said display is an interactive display.

10. The system according to claim 7, wherein the two or more anatomical elements are portions of the same bone.

11. A method for determining three dimensional positions of points in radiographic images comprising:
capturing a first set of two or more radiographic images of a first anatomical element and at least a portion of a reference object including reference markings, which reference markings are distinguishable from each other based on a visual characteristic and have known or ascertainable geometric characteristics and spatial relationships between them, wherein the first set of images are captured from at least two different angles and the anatomical element and the reference object remain stationary while the two or more images are captured; and
extrapolating a three dimensional position, in relation to said reference object, of a first point on the first anatomical element, which first point is visible in the two or more images, wherein said extrapolating factors a geometric characteristic of projections of a reference marking appearing in a field of view of the two or more images.

12. The method according to claim 11, further comprising extrapolating a three dimensional position, in relation to said reference object, of a second point on the first anatomical element, which second point is visible in the two or more images, wherein said extrapolating factors a geometric characteristic of projections of a reference marking appearing in a field of view of the two or more images; and
extrapolating a three dimensional position and orientation, in relation to the reference object, of the first anatomical element, based on the extrapolated positions of the first and second points.

13. The method according to claim 11, further comprising:
capturing a second set of two or more radiographic images of a second anatomical element and at least a portion of the reference object, wherein the images of the second set of images are captured from at least two different angles and the first and second anatomical elements and the reference object remain stationary while the two sets of images are captured;
extrapolating a three dimensional position, in relation to said reference object, of a second point on the second anatomical element, which second point is visible in the two images of the second set, wherein said extrapolating of the second point position factors a geometric characteristic of projections of a reference marking appearing in a field of view of the two or more images of the second set; and
extrapolating a distance between the first and second points, based on the extrapolated positions of the first and second points.

14. The method according to claim 13, further comprising determining an alignment of the first and second points in relation to said reference object, based on the extrapolated positions of the first and second points.

15. The method according to claim 12, further comprising:
capturing a second set of two or more radiographic images of a second anatomical element and at least a portion of the reference object, wherein the images of the second set of images are captured from at least two different angles and the first and second anatomical elements and the reference object remain stationary while the two sets of images are captured;
extrapolating a three dimensional position, in relation to said reference object, of a third and fourth point on the second anatomical element, which third and fourth points are visible in the two images of the second set, wherein said extrapolating of third and fourth point positions factors a geometric characteristic of projections of a reference marking appearing in a common field of view of the two or more images of the second set;
extrapolating a three dimensional position and orientation, in relation to the reference object, of the second anatomical element, based on the extrapolated positions of the third and fourth points; and
determining a three dimensional spatial relationship between the first and second anatomical elements, based on the extrapolated three dimensional positions and orientations of the first and second anatomical elements in relation to the reference object.

16. The method according to claim 15, wherein the first and second anatomical elements are portions of the same bone.

17. The method according to claim 11, further comprising displaying a graphic rendering of the extrapolated position.

18. The method according to claim 15, further comprising displaying a graphic rendering of the extrapolated positions and orientations.
